(19) United States
(12) Patent Application Publication
(10) Pub. No.: US 2009/0256421 A1
(43) Pub. Date: Oct. 15, 2009

(54) MOBILE POWER GENERATION SYSTEM AND METHOD OF CONSTRUCTING THE SAME

(76) Inventor: Kunmo Chung, Great Falls, VA (US)

Correspondence Address: LAW OFFICE OF DUANE S. KOBAYASHI, P.O. Box 4160, Leesburg, VA, 20177, US

(21) Appl. No.: 12/363,261

(22) Filed: Jan. 30, 2009

(30) Foreign Application Priority Data
Jan. 31, 2008 (KR) 10-2008-0010265
Oct. 27, 2008 (KR) 10-2008-0105457

(51) Int. Cl. H02J 3/00

(52) U.S. Cl. 307/11

(57) ABSTRACT

The present invention relates to a mobile power generation system and method of constructing the system. The mobile power generation system includes a power generation module configured to generate and transmit electricity, a mobile module configured to be movable and to allow the power generation module to be assembled therein, an additional module configured to protect the mobile module against external physical shocks and fix the mobile module at a designated location, and a site configured to allow the mobile module to be fixed therein. The present invention is advantageous in that mobile power generation facilities are modularized and produced in a technically-intensive manner, the construction time and expenses thereof are decreased, existing sites are reused, and the mobile power generation facilities are safely protected against physical shocks such as earthquakes because they are moved and float through a mobile module.

This application claims the benefit under 35 U.S. C. § 119(a) of Korean Patent Application No. 10-2008-0010265, filed Jan. 31, 2008, and Korean Patent Application No. 10-2008-0105457, filed Oct. 27, 2008, the entire contents of each application are incorporated herein by reference.

### BACKGROUND

1. Field of the Invention

The present invention relates, in general, to a mobile power generation system, and, more particularly, to a mobile power generation system and method of constructing the system, which enable a site to be built while enabling power generation facilities to be constructed in the form of high-quality standardized modules and to be assembled in a mobile module by intensively using the advanced technology through groups of experts and skilled workers in respective areas of nuclear power generation and by using precise equipment, thus reducing the time required for the entire construction process, improving construction quality, reusing existing sites, and rapidly performing maintenance on a per-module basis.

2. Introduction

A power plant is a station provided with a motor, a power generator, and auxiliary machines to generate electric power, and is a system facility for producing electric power by converting the flow of energy attributable to predetermined fuel into dynamic energy and converting the dynamic energy into electric power using electromagnetic induction.

A typical thermoelectric power plant is problematic in that, since a large amount of fuel is required, a lot of expense and time is required for the transportation and storage of fuel. Technology which somewhat solves this problem is power generation technology using atomic energy or nuclear fuel.

Since a power plant system produces electric power by rotating a turbine using steam energy that is generated through the consumption of fuel, a site having a predetermined area and facilities therefore are required. For safety, if the specified usage period or lifespan of a power plant system has been exceeded and the power plant system becomes old, then replacement, maintenance, reconstruction, etc. are required.

When nuclear fuel is used, there is an advantage in that, since the amount or volume of nuclear fuel consumed is reduced, and the fuel can be used for a long period of time, the amount of required fuel, the number of times that the fuel is transported, and the time required for the transportation have been improved upon, but there is a problem in that, since radioactivity, nuclear waste material, etc. are produced, it is difficult to reuse and maintain a site.

Further, once a power plant is constructed on the ground, it cannot be moved, so that the selection and decision of a site must be cautiously conducted at the beginning in consideration of the surrounding environment and base facilities of the power plant.

Generally, in order to construct a nuclear power plant, a period of about seven years is required. Further, a nuclear power plant is an advanced system in which highly-developed technology and expensive equipment are intensively used, and the viable lifespan thereof is regarded as a period of about 30 to 40 years. Further, an old nuclear power plant, the lifespan of which has been exceeded, is disposed of for safety reasons.

The nuclear fuel that is used in such a nuclear power plant and the facilities in which it was used are contaminated with nuclear radioactivity. Accordingly, when exposed to the air without the use of specific shielding equipment, the nuclear fuel and the facilities are so poisonous that the surrounding environment is devastated for a long period of time and people are also fatally affected. Due thereto, the site which is no longer being used must be closed and isolated for a long period of time for the purposes of contamination prevention and management.

Further, thermoelectric power plants and nuclear power plants generate power by rotating a turbine using high-pressure and high-temperature steam generated through the heating of water, and use a large quantity of water as cooling water so as to cool both the steam and facilities used for power generation, and thus such thermoelectric power plants are generally installed in places enabling the continuous supply of ordinary water or water designated for industrial use.

Therefore, in order to reuse a nuclear power plant site, existing facilities must be safely dismantled and reconstructed, and thus there are problems in that a lot of time and expense are required and technical difficulty is present.

Further, there is a problem in that, since a nuclear power plant is generally constructed in an isolated and unfrequented place, it is hard for a plurality of pieces of highly-developed precise equipment and a group of skilled experts to be transferred to and stay in that place, thus requiring a lot of time and expense to highly intensively use and stabilize nuclear power generation-related technologies.

In addition, a nuclear power plant has safety problems because it is very vulnerable to shocks, such as earthquakes, arising from topographical insecurity.

### SUMMARY

Accordingly, the present invention has been made keeping in mind the above problems occurring in the prior art, and a first object of the present invention is to provide a mobile power generation system, which allows a skilled production team consisting of technical experts to produce respective modularized parts of nuclear power generation facilities using high-precision equipment in a technically-intensive manner.

A second object of the present invention is to provide a method of constructing a mobile power generation system, which builds a site while producing respective modularized parts of nuclear power generation facilities.

A third object of the present invention is to provide a mobile power generation system, which modularizes and standardizes respective parts of nuclear power generation facilities in a place at which optimal production environments are prepared, thus enabling the mass production of mobile power generation systems while guaranteeing the quality thereof.

A fourth object of the present invention is to provide a mobile power generation system and method of constructing the system, which enable modularized nuclear power generation facilities to be assembled in a mobile module, thus facilitating the movement of the facilities and enabling the facilities to be precisely fixed at a designated location in a powered or non-powered manner.

A fifth object of the present invention is to provide a mobile power generation system and method of constructing the system, which enable nuclear power generation facilities to be produced, assembled and replaced for maintenance on a per-module basis.

A sixth object of the present invention is to provide a mobile power generation system and method of constructing the system, which enable nuclear power generation facilities to be assembled in a mobile module, so that the replacement of aged nuclear power generation facilities is facilitated, thus enabling existing sites to be reused.

A seventh object of the present invention is to provide a mobile power generation system and method of constructing the system, which can enable nuclear power generation facilities to be assembled in a floating-type mobile module, which floats on water and includes a shock-absorbing device, and which can fix the mobile module at a designated site, thus protecting the nuclear power generation facilities against physical shocks such as earthquakes.

An eighth object of the present invention is to provide a mobile power generation system and method of constructing the system, which can enable nuclear power generation facilities to be easily moved to and fixed at a designated place, and which can generate and supply power using energy selected from among various energy sources including nuclear energy.

In order to accomplish the above objects, the present invention provides a mobile power generation system, comprising a power generation module configured to generate and transmit electricity, a mobile module configured to be movable and to allow the power generation module to be assembled therein, an additional module configured to protect the mobile module against external physical shocks and fix the mobile module at a designated location, and a site configured to allow the mobile module to be fixed therein.

Preferably, the power generation module comprises a power generation unit for generating electricity using any one selected from various energy sources including nuclear fuel, fossil fuel, natural fuel, bio fuel, hydrogen fuel, and a fuel cell, and a power transmission unit for transmitting the electricity generated by the power generation unit.

Preferably, the site is implemented as any one selected from among a ground site and a sea site in which the mobile module is fixed.

Preferably, the mobile module is moved to a ground site including a dock, one end of which is open, and a protection gate, which is installed at the open end of the dock and is configured to open or close the dock, so that the mobile module is fixed in the dock.

Preferably, the dock is implemented as any one selected from among a dry-type dock and a wet-type dock.

Preferably, the mobile module further comprises a location control unit for performing control such that the power generation module is not moved from a designated location when the power generation module is assembled in the mobile module and is moved to the designated location.

Preferably, the additional module comprises at least one selected from among a powered fixing unit for fixing the mobile module at a designated location using power, and a non-powered fixing unit for fixing the mobile module at the designated location without using power.

In addition, in order to accomplish the above objects, the present invention provides a method of constructing a mobile power generation system, comprising a construction and building step of simultaneously performing one or more selected from among construction of a power generation module, construction of a mobile module, construction of an additional module, and building of a site, an assembly movement step of assembling the power generation module and the additional module in the mobile module, moving the mobile module to a designated site, and fixing the mobile module at the designated site, and an operation step of generating and transmitting electricity by operating the power generation module, and maintaining the power generation module.

Preferably, the construction and building step comprises a module step of simultaneously constructing the power generation module, including a power generation unit for generating electricity using energy and a power transmission unit for transmitting the electricity generated by the power generation unit, and the additional module, including a shock-absorbing unit for absorbing shocks and a fixing unit for fixing the power generation module, a mobile module step of constructing the mobile module in which the power generation module and the additional module are assembled and which is moved, simultaneously with performance of the module step, a site step of building the site in which the mobile module is fixed, simultaneously with performance of the module step, and a power reception module step of constructing a power reception module for receiving the electricity from the power transmission unit simultaneously with performance of the module step.

Preferably, the construction and building step is performed to simultaneously construct or build one or more selected from among a power generation unit and a power transmission unit of the power generation module, the mobile module, a shock-absorbing unit and a fixing unit of the additional module, the site, and a power reception module.

Preferably, the power generation module, the mobile module, the additional module, and the power reception module are constructed in a technically-intensive manner and are standardized in a production environment provided with skilled technical experts and precise measurement equipment, thus being produced in large quantities to guarantee production quality.

As described above, the present invention having the above construction is advantageous for industrial applications in that, since nuclear power generation facilities are produced in a place in which nuclear experts, skilled production teams and perfect equipment are provided, nuclear power generation modules in which the highest technology is intensively used can be produced.

Further, the present invention having the above construction is advantageous for convenient use in that, since a site is built while nuclear power generation facilities are modularized and produced, the process and time required for the construction of a nuclear power generation system can be reduced, and the construction expenses are also decreased.

Further, the present invention having the above construction is advantageous for industrial applications in that, since nuclear power generation facilities are standardized and produced on a per-module basis in a place at which production environments are prepared, mass production is possible, production quality is guaranteed, and the production expenses are reduced.

Further, the present invention having the above construction is advantageous for industrial applications in that, since nuclear power generation facilities are assembled in a mobile module, a process for dismantling aged facilities and installing new facilities is simplified, and existing sites can be rapidly reused.

Further, the present invention having the above construction is advantageous for convenient use in that, when a failure occurs in any one portion of modularized nuclear power generation facilities, only a corresponding module is replaced with a new module and the new module is applied, thus rapidly performing maintenance and reducing the expenses.

Further, the present invention having the above construction is advantageous for industrial applications in that, since nuclear power generation facilities are provided with shock-absorbing equipment, are assembled in a floating-type mobile module, and are fixed at a site, the nuclear power generation facilities can be protected against physical shocks attributable to natural disasters such as earthquakes.

Further, the present invention having the above construction is advantageous for industrial applications in that, since nuclear power generation facilities are assembled in a mobile module, movement to and removal from a designated place are facilitated, and in that, since energy selected from among various energy sources including nuclear energy is used, power can be reliably generated and supplied.

In addition, the present invention having the above construction is advantageous for convenient use in that the mobile module can be accurately and precisely fixed in a designated location by using non-powered fixing units or powered fixing units for receiving a location control signal.

### BRIEF DESCRIPTION OF THE DRAWINGS

The above and other objects, features and advantages of the present invention will be more clearly understood from the following detailed description taken in conjunction with the accompanying drawings.

FIG. 1 is a diagram showing the construction of a modularized mobile power generation system according to an embodiment of the present invention.

FIG. 2 is a diagram showing the state in which power generation facilities are fixed at the ground site of the mobile power generation system according to an embodiment of the present invention.

FIG. 3 is a diagram showing the state in which power generation facilities are fixed at the sea site of the mobile power generation system according to another embodiment of the present invention.

FIG. 4 is a diagram showing a flowchart of a method of constructing a mobile power generation system according to an embodiment of the present invention.

### DETAILED DESCRIPTION

Hereinafter, embodiments of a mobile power generation system and method of constructing the system according to the present invention will be described in detail with reference to the attached drawings.

In the description of embodiments of the present invention, drawings and description of technical content which is not directly related to the present invention and is well known to those skilled in the art are omitted, so that the gist of the present invention may remain clear.

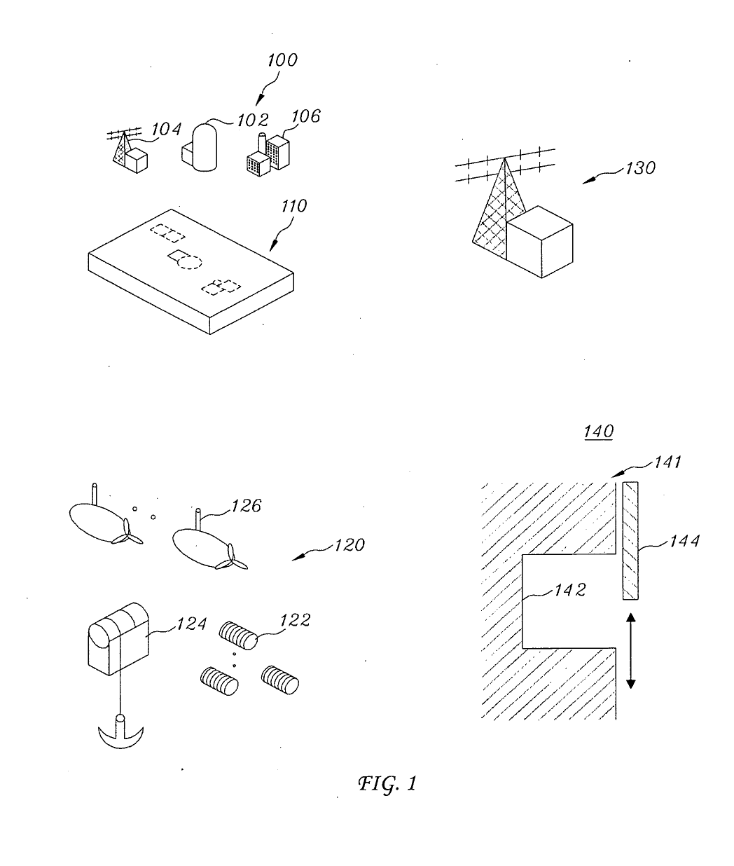

FIG. 1 is a diagram showing the construction of a modularized mobile power generation system according to an embodiment of the present invention.

Hereinafter, a description will be made with reference to FIG. 1. The mobile power generation system includes a power generation module 100 for generating and transmitting electricity, a mobile module 110 configured to be movable and to allow the power generation module 100 to be assembled therein, an additional module 120 configured to protect the mobile module 110 against external physical shocks and fix the mobile module 110 at a designated location, a power reception module 130 configured to receive electricity generated by and transmitted from the power generation module, and a site 140 configured to allow the mobile module to be fixed therein.

The power generation module 100 includes a power generation unit 102 for generating high-pressure steam by heating water or liquid using any one selected from among various energy sources such as nuclear fuel, fossil fuel, natural fuel, bio fuel, hydrogen fuel, and a fuel cell, and generating electricity by rotating a turbine using the generated high-pressure steam, a power transmission unit 104 for transmitting the electricity generated by the power generation unit 102, and a management unit 106 for managing a power generation system including the power generation unit 102 and the power transmission unit 104 and performing control such that the location at which the power generation system is fixed can be stably maintained.

The energy sources may include tidal power, wind power, solar power, wave power, water temperature, etc.

The mobile module 110 may include construction that is movable under its own or external power, such as a barge, a ship or a vehicle. In the present invention, a description will be made mainly on the basis of a barge floating on the water. The mobile module 110 is provided with the function of a location control unit for allowing the mobile module to be fixed at a designated location without being moved.

The additional module 120 includes shock-absorbing units 122 configured to protect the mobile module 110 against external shocks, non-powered fixing units 124 configured to fix the mobile module 110 at a designated location without using power, and powered fixing units 126 driven by power and configured to fix the mobile module at a designated location through a control operation. The shock-absorbing units 122 are configured to absorb or block physical shocks, are implemented using one or more selected from among all components, such as airbags, spring elastic bodies, rubber elastic bodies, and other materials capable of absorbing or blocking shocks, and are uniformly disposed on the side surface and the bottom surface of the mobile module 110 at regular intervals, thus absorbing, buffering or blocking external physical shocks.

The power generation module 100 composed of the power generation unit 102, the power transmission unit 104 and the management unit 106, the mobile module 110, and the additional module 120 composed of the shock-absorbing units 122, the non-powered fixing units 124 and the powered fixing units 126 have been separated for convenience of description of the present invention by way of example, but the present invention may be separated into more detailed modules. The detailed modules are produced as technically-intensive modules because they are produced at the working place in which experts, technical experts and skilled workers of related areas constitute a team, high-precision measurement equipment, processing equipment and transport equipment are provided, and production facilities are prepared. Further, there are advantages in that, since repetitive production is made on a per-module basis, mass production is possible, production expenses are decreased, and the stabilization of production quality is guaranteed. There are additional advantages in that, when a failure occurs, replacement or substitution is performed on a per-module basis, thus rapidly realizing maintenance and reducing required expenses. Further, since production is made on a per-module basis, standardization is possible, and thus production can be performed without spatial restrictions. In this case, competition as to development of the technology between production companies can be provoked.

The site 140 is a place in which an assembled mobile module 110 is fixed, and includes a ground site 141 and a sea site 145. At the site 140, the power reception module 130 is provided.

For example, the ground site 141 may include a dock 142 which is open at one end and which is configured to allow the mobile module 110 to be fixed therein, and a protection gate 144 which is installed at the open end of the dock 142. The dock 142 is implemented as one of a wet-type dock filled with water so that the mobile module 110 is maintained in a floating state, and a dry-type dock configured to allow the mobile module 110 to be placed on the exposed bottom of the dock from which water is removed.

The building of the site 140 is performed simultaneously with the production and manufacturing of the respective technically-intensive modules 102, 104, 106, 110, 122, 124 and 126, and thus the entire period and expenses required for the construction of nuclear power generation facilities can be reduced.

Since the mobile module 110 is provided with respective shock-absorbing units 122 on its side and bottom surfaces, the shock-absorbing units 122 absorb shocks even if external shocks of a predetermined magnitude are applied, thus enabling the mobile module 110 to be safely protected. When the mobile module 110 is located in the dock 142 filled with water or at a sea site 145, it is subject to buoyancy to float on water, so that shock absorption is realized by water even if external shocks, such as earthquakes of a predetermined magnitude, occur, thus enabling the mobile module to be safely protected.

When the mobile module 110 floats on water, one or more selected from among the non-powered fixing units 124 and the powered fixing units 126 for preventing the movement of the mobile module 110 are used. When the mobile module 110 is located at a sea site 145 having a large water depth, the powered fixing units 126 are preferably used so that the mobile module 110 is consistently maintained at a designated place without being moved due to the influence of waves, ocean currents or the like, in the state in which the mobile module is fixed at the designated place.

The non-powered fixing units 124 are configured to fix the mobile module 110 at the designated location without the mobile module 110 on the water of the site 140 moving as a result of tidal currents, shocks, etc. A plurality of non-powered fixing units 124 may be provided on end portions of the mobile module 110. Each of the non-powered fixing units includes a winding part, a rope or chain, and an anchor part. The winding part is configured to wind or unwind a rope (including a typical rope, a cord and a cable) or a chain through the rotation thereof. The rope or chain is wound around or unwound from the winding part, with one end thereof fixed at the winding part. The anchor part is detachably fixed to the other end of the rope or chain, and is thrown in the water or is bound to a relevant fixing unit located on the ground, thus fixing the mobile module to be immovable. When the site 140 is a dry-type dock, the mobile module 110 can be fixed using a chain or the like.

The powered fixing units 126 are precisely operated under the control of the location control unit provided in the mobile module 110 so as to maintain the location of the mobile module at the designated location. The location control unit includes a Global Positioning System (GPS). The location control unit may be provided in the management unit 106 assembled in the mobile module 110.

The mobile module 110 has a structure capable of floating on the water, and is configured such that the power generation unit 102, the power transmission unit 104, and the management unit 106 constituting the power generation module 100 are assembled therein in a modularized state. When its own power is provided, the mobile module 110 can move by itself, whereas when its own power is not provided, the mobile module 110 can move by way of a tugboat or the like. In the present invention, the term ‘sea’ includes a lake, a river, a marsh, etc., but, for convenience of description, these terms are just referred to as a sea.

For example, when it is assumed that the mobile module 110 has a weight of about one hundred fifty thousand Ton (t), and the power generation module 100 generates power using nuclear energy, the power generation system can be constructed to generate power of about a million Kilowatt (KW). Further, since the power generation system can be easily moved, entire portions of aged nuclear power generation facilities are easily dismantled and replaced with new facilities, and the existing sites can be immediately reused. Therefore, the expenses required for the management of nuclear power generation facilities can be reduced.

The dock 142 is formed at the ground site 141 built on the seaside, riverside, lakeside, the borders of a marsh or on the ground. The dock 142 includes a wet-type dock provided with an alongside pier facility for anchoring the mobile module 110, which is floating on the water and in which the power generation module 100 is constructed and assembled, and a dry-type dock configured to fix the mobile module on the ground in the state in which water is removed from the dock and the bottom of the dock is exposed to the outside. Any one selected from among the wet-type dock and the dry-type dock is used. The building of the site is performed simultaneously with the construction of the respective modules constituting the nuclear power generation facilities, and thus there are advantages in that the entire process time or construction period required for the nuclear power generation facilities is shortened, and construction expenses are reduced.

At the open inlet of the dock 142, the protection gate 144 is installed and is configured to open or close the dock 142. The protection gate 144 is spaced apart from the dock 142 by a predetermined distance and does not tightly shut the open inlet of the dock 142, thus forming a water flow path along which water spontaneously flows into or out from the dock 142 via the space between the dock 142 and the protection gate 144. Further, the protection gate 144 blocks waves attributable to natural disasters, such as typhoons or tidal waves, thus preventing the mobile module 110 from deviating from the dock 142 while protecting the mobile module 110 in the dock 142. When the dry-type dock 142 is used, the protection gate 144 may not be necessary.

In this case, the mobile module 110 absorbs or buffers physical shocks of a predetermined magnitude in the dry-type dock or the wet-type dock through the plurality of shock-absorbing units 122 provided on its side surface and bottom surface. In particular, when the mobile module 110 is placed in the wet-type dock or at the sea site, it is protected against shocks, such as earthquakes of a predetermined magnitude, thanks to water.

Therefore, the nuclear power generation facilities assembled in the mobile module 110 block or absorb physical shocks of a predetermined magnitude occurring due to natural disasters such as earthquakes, and thus are safely protected. Further, since the nuclear power generation facilities are assembled in the mobile module, they can be easily moved to a designated place and can be easily replaced.

The power reception module 130 is provided at the ground site 141, and receives electricity from the power transmission unit 104 of the mobile module 110 on the ground.

That is, the mobile module 110 is advantageous in that when facilities are aged and intended to be replaced or are moved to another designated place, the connection between the power reception module 130 and the power transmission unit 104 is severed, and thus the mobile module 110 can be easily and rapidly moved to a desired place or a designated place using a tugboat or the like. Therefore, the existing site of the power plant can be rapidly reused.

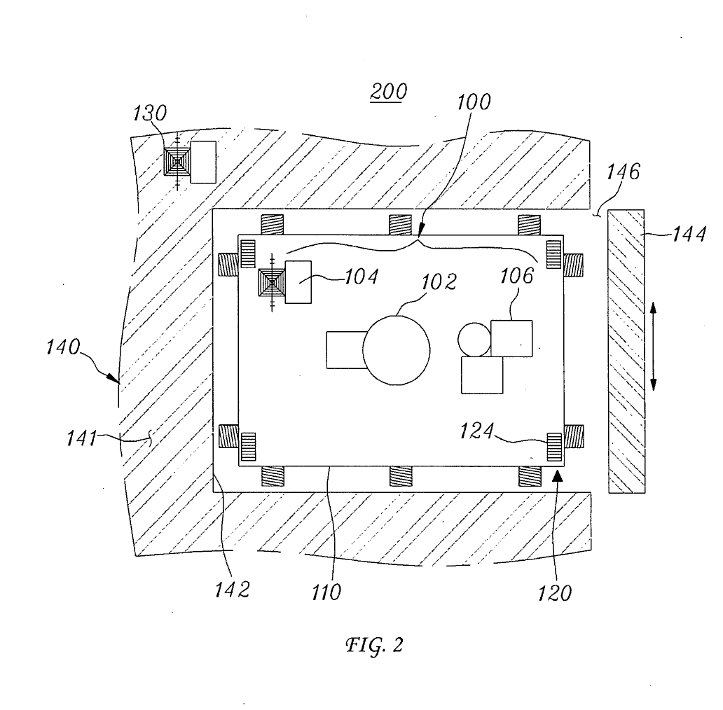

FIG. 2 is a diagram showing the state in which the mobile power generation system is fixed at the ground site according to an embodiment of the present invention.

Hereinafter, the state in which power generation facilities are fixed at the ground site of the mobile power generation system is described in detail with reference to FIG. 2. The power generation module 100 composed of the power generation unit 102, the power transmission unit 104 and the management unit 106, and the additional module 120 composed of the shock-absorbing units 122 and the non-powered fixing units 124 are assembled in the mobile module 110.

The assembled mobile module 110 is lying at anchor in the dock 142 of the ground site 141 through a tugboat, and is fixed in the dock 142 using the non-powered fixing units 124 so as to be immovable. The protection gate 144 is closed to prevent the mobile module 110 from deviating from an anchored state. In this case, the water flow path 146 is formed between the dock 142 and the protection gate 144 to allow water in the dock to circulate therethrough to the outside, thus enabling cooling water or the like used for power generation to be continuously supplied to the dock. Further, the dock 142 is generally filled with water. In the case of the wet-type dock filled with water, water absorbs shocks occurring due to an earthquake of a predetermined magnitude or the like, so that the mobile module 110 in which the power generation module 100 is assembled is safely protected. In the case of the dry-type dock from which water is removed and which is maintained in a dry state, the mobile module 110 is safely protected against shocks of a predetermined magnitude by the plurality of shock-absorbing units 122 assembled to the bottom and side surfaces of the mobile module 110. When the nuclear power generation facilities assembled in the mobile module 110 are aged, they are easily dismantled from the mobile module 110 and are easily replaced with new facilities, and thus the existing site 141 can be rapidly reused.

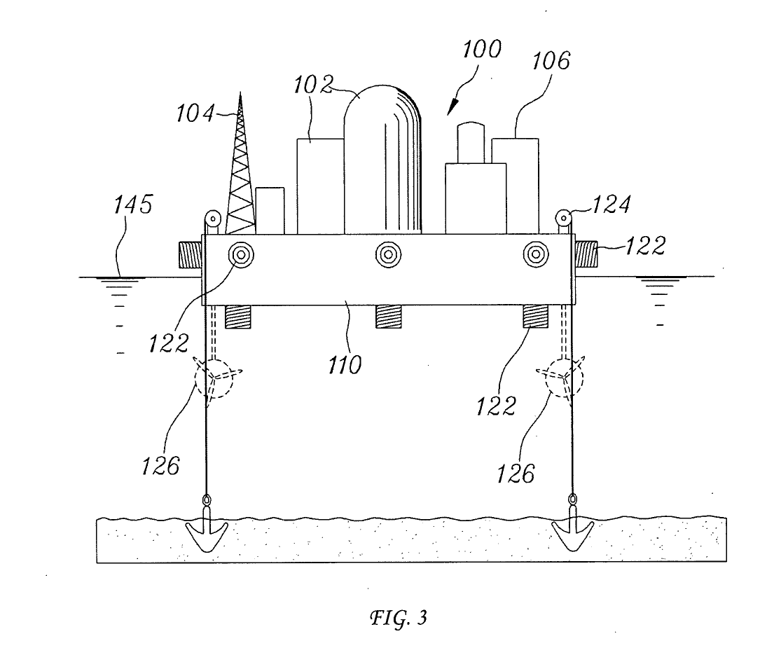

FIG. 3 is a diagram showing the state in which power generation facilities are fixed at the sea site of the mobile power generation system according to another embodiment of the present invention.

Hereinafter, with reference to FIG. 3, a description will be made. The mobile module 110 in which the power generation module 100 is constructed and assembled is moved to a designated location of the sea site 145, such as a river, a lake or a sea having a wide water surface or a large water depth. The rope or chain, wound around each of the non-powered fixing units 124, is unwound by rotating the winding part of the non-powered fixing unit 124, and the anchor part reaches the bottom of the sea, and thus the mobile module 110 is fixed at a predetermined location. When the mobile module 110 is desired to be moved to another place, the rope or chain is wound by rotating the winding part of the non-powered fixing unit 124 in an opposite direction, and the anchor part, having reached the bottom, is lifted up to release the fixed state. Then, the mobile module 110 is moved to another place using a tugboat or the like.

Further, when the powered fixing units 126 indicated by dotted lines in the drawing are used, the location control unit provided in the mobile module 110 individually controls the plurality of powered fixing units 126 using location information received from a GPS, thus performing location control so that the mobile module 110 is fixed at a designated location on the sea. Since the powered fixing units 126 precisely generate respective propulsive forces in their controlled directions in response to a signal from the location control unit, the mobile module 110 is fixed at the designated location without being moved. At this time, the location control unit preferably uses a GPS signal.

Therefore, after the power generation system has been moved to a designated location, it can be precisely fixed at the designated location.

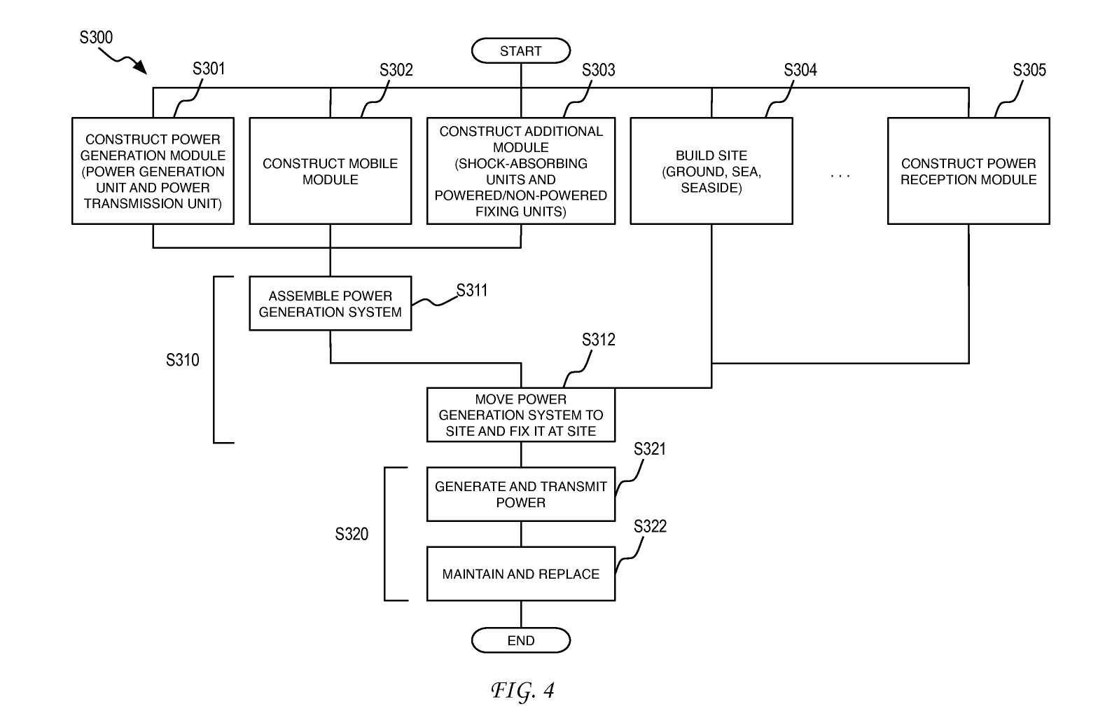

FIG. 4 is a flowchart showing a method of constructing a mobile power generation system according to an embodiment of the present invention.

Hereinafter, a description will be made with reference to FIG. 4. The construction method includes a construction and building step S300 of simultaneously performing one or more selected from among the construction of the power generation module, the construction of the mobile module, the construction of the additional module, and the building of the site, an assembly movement step S310 of assembling the power generation module and the additional module in the mobile module, moving the mobile module to a designated site, and fixing the mobile module at the site, and an operation step S320 of generating electricity by operating the power generation module, transmitting the electricity, and maintaining the power generation module.

In detail, at the construction and building step S300, the power generation module 100, including the power generation unit 102 for generating electricity using energy, the power transmission unit 104 for transmitting the electricity generated by the power generation unit 102, and the management unit 106 for managing and controlling the normal operation of the power generation module 100 while selectively performing location control, is constructed at step S301. Further, the mobile module 110, in which the power generation module 100 and the additional module 120 are assembled and which is moved using any one elected from among a method using its own power and a method using a tugboat without using power, is constructed at step S302. The additional module 120, including the shock-absorbing units 122 for absorbing shocks, the non-powered fixing units 124 and the powered fixing units 126, is constructed at step S303. The site 140 in which the mobile module 110 is fixed is built at step S304. The power reception module 130 for receiving the electricity transmitted from the power transmission unit 104 of the power generation module 100 is constructed at step S305.

Further, one or more selected from among the construction of the power generation module at step S301, the construction of the mobile module at step S302, the construction of the additional module at step S303, the building of the site at step S304, and the construction of the power reception module at step S305 are simultaneously performed.

That is, the construction and building step S300 is performed to simultaneously construct one or more selected from among the power generation module including the power generation unit and the power transmission unit, the mobile module, the additional module including the shock-absorbing units and the fixing units, the site, and the power reception module. Therefore, there is an advantage in that the period and expenses required for the construction of a nuclear power plant are reduced.

Further, the mobile power generation system is advantageous in that it is produced in a technically-intensive manner and is standardized in an environment in which nuclear energy-related technical experts, skilled workers and technical engineers constitute a team, high-precision measurement equipment and transport equipment are provided, and the supply of goods is smoothly performed, and thus a high-quality power generation system can be produced.

In detail, at the assembly movement step S310, the constructed power generation module and additional module are assembled in the mobile module at step S311, and the mobile module is moved to and fixed at a designated site at step S312. Methods of fixing the mobile module include a method using non-powered fixing units and a method using powered fixing units. At this time, the mobile module is moved using a tugboat or the like. When the designated site is a ground site, the power transmission unit 104 is connected to the power reception module 130 located at the ground site after the mobile module has moved to the ground site. In this case, a wired communication means and an additional device for the supply of fuel are also connected between the ground and the mobile module 110.

Further, when the mobile power generation facilities are installed at the sea site 145, it is moved to a designated sea site, such as a lake, a river or a sea, by using a tugboat or the like. The anchor part of each non-powered fixing unit 124 reaches the bottom of water, or each powered fixing unit 126 is operated under the control of the location control unit, so that the locations of the mobile power generation facilities are fixed, and the power transmission unit 104, the power reception module 130 and other required additional devices are connected to each other. Therefore, the mobile power generation facilities can be efficiently shielded or protected from certain physical shocks occurring due to natural disasters such as earthquakes.

As described above, electricity, generated while the facilities are moved to and operated at a designated location of the ground or sea site, is operated to be transmitted to the power reception module through the power transmission unit at step S321. When the mobile power generation system is moved to another location, it is moved to a designated location using a tugboat or a transport means, and when maintenance is required due to aging or the like, the system is replaced on a per-module basis at step S322.

Therefore, maintenance is rapidly performed and expenses are reduced. Further, when the entire mobile module of the mobile power generation system fixed at the ground site 141 is aged and cannot be used any more, the mobile module is replaced with a new mobile module, and thus the ground site can be reused.

As described above, the present invention having the above construction is advantageous for industrial applications in that, since nuclear power generation facilities are produced in a place in which nuclear experts, skilled production teams and perfect equipment are provided, nuclear power generation modules in which the highest technology is intensively used can be produced.

Further, the present invention having the above construction is advantageous for industrial applications in that, since nuclear power generation facilities are standardized and produced on a per-module basis in a place at which production environments are prepared, mass production is possible, production quality is guaranteed, and the production expenses are reduced.

Further, the present invention having the above construction is advantageous for industrial applications in that, since nuclear power generation facilities are provided with shock-absorbing equipment, are assembled in a floating-type mobile module, and are fixed at a site, the nuclear power generation facilities can be protected against physical shocks attributable to natural disasters such as earthquakes.

Further, the present invention having the above construction is advantageous for industrial applications in that, since nuclear power generation facilities are assembled in a mobile module, movement to and removal from a designated place are facilitated, and in that, since energy selected from among various energy sources including nuclear energy is used, power can be reliably generated and supplied.

What is claimed is:

1. A mobile power generation system, comprising:
a power generation module configured to generate and transmit electricity;
a mobile module configured to be movable and to allow the power generation module to be assembled therein;
an additional module configured to protect the mobile module against external physical shocks and fix the mobile module at a designated location; and
a site configured to allow the mobile module to be fixed therein.

2. The mobile power generation system according to claim 1, wherein the power generation module comprises:
a power generation unit for generating electricity using any one selected from various energy sources including nuclear fuel, fossil fuel, natural fuel, bio fuel, hydrogen fuel, and a fuel cell; and
a power transmission unit for transmitting the electricity generated by the power generation unit.

3. The mobile power generation system according to claim 1, wherein the site is implemented as any one selected from among a ground site and a sea site in which the mobile module is fixed.

4. The mobile power generation system according to claim 1, wherein the mobile module is moved to a ground site including a dock, one end of which is open, and a protection gate, which is installed at the open end of the dock and is configured to open or close the dock, so that the mobile module is fixed in the dock.

5. The mobile power generation system according to claim 4, wherein the dock is implemented as any one selected from among a dry-type dock and a wet-type dock.

6. The mobile power generation system according to claim 1, wherein the mobile module further comprises a location control unit for performing control such that the power generation module is not moved from a designated location when the power generation module is assembled in the mobile module and is moved to the designated location.

7. The mobile power generation system according to claim 1, wherein the additional module comprises at least one selected from among a powered fixing unit for fixing the mobile module at a designated location using power, and a non-powered fixing unit for fixing the mobile module at the designated location without using power.

8. A method of constructing a mobile power generation system, comprising:
a construction and building step of simultaneously performing one or more selected from among construction of a power generation module, construction of a mobile module, construction of an additional module, and building of a site;
an assembly movement step of assembling the power generation module and the additional module in the mobile module, moving the mobile module to a designated site, and fixing the mobile module at the designated site; and
an operation step of generating and transmitting electricity by operating the power generation module, and maintaining the power generation module.

9. The method according to claim 8, wherein the construction and building step is performed to simultaneously construct or build one or more selected from among a power generation unit and a power transmission unit of the power generation module, the mobile module, a shock-absorbing unit and a fixing unit of the additional module, the site, and a power reception module.

10. The method according to claim 9, wherein the power generation module, the mobile module, the additional module, and the power reception module are constructed in a technically-intensive manner and are standardized in a production environment provided with skilled technical experts and precise measurement equipment, thus being produced in large quantities to guarantee production quality.
